(19) United States
(12) Patent Application Publication
(10) Pub. No.: US 2025/0341720 A1
(43) Pub. Date: Nov. 6, 2025

(54) OPTICAL WAVEGUIDE STRUCTURE, OPTICAL MODULE AND HEAD-MOUNTED DISPLAY DEVICE

(71) Applicant: Goertek Optical Technology Co., Ltd., Weifang, Shandong (CN)

(72) Inventors: Rudong Wei, Shandong (CN); Yi Rao, Shandong (CN); Xiao Wu, Shandong (CN); En Zhao, Shandong (CN); Lichao Dong, Shandong (CN); Xin Cheng, Shandong (CN)

(73) Assignee: Goertek Optical Technology Co., Ltd., Weifang, Shandong (CN)

(21) Appl. No.: 18/868,370

(22) PCT Filed: Jun. 28, 2022
(86) PCT No.: PCT/CN2022/102014

§ 371 Date: Nov. 22, 2024

(30) Foreign Application Priority Data
May 24, 2022 (CN) 202210572848.6

(51) Int. Cl. G02B 27/01

(52) U.S. Cl. CPC G02B 27/0172; G02B 2027/0123

(57) ABSTRACT

Embodiments of the present disclosure provide an optical waveguide structure, an optical module and a head-mounted display device; wherein the optical waveguide structure comprises an optical waveguide, and a coupling-out zone and at least two coupling-in zones provided on the optical waveguide; the at least two coupling-in zones are configured for coupling in light of different colors; the coupling-out zone is configured for coupling the light, which has been coupled in through the at least two coupling-in zones, out of the optical waveguide at different field angles, respectively.

### CROSS-REFERENCE TO RELATED APPLICATIONS

The present disclosure is a National Stage of International Application No. PCT/CN2022/102014, filed on Jun. 28, 2022, which claims priority to a Chinese patent application No. 202210572848.6 filed with the CNIPA on May 24, 2022, both of which are hereby incorporated by reference in their entireties.

### TECHNICAL FIELD

Embodiments of the present disclosure relates to the technical field of near-eye display, and particularly to an optical waveguide structure, an optical module and a head-mounted display device.

### BACKGROUND

In augmented reality (AR) displays, such as AR head-mounted display devices, an optical waveguide is typically employed as a core component. Incident light can be transmitted within the optical waveguide based on the principle of total internal reflection. Specifically, diffraction gratings are provided on surfaces of the optical waveguide, which are configured to couple light into the interior of the optical waveguide or to couple light out of the optical waveguide for display and imaging.

In existing related technologies, three-grating optical waveguides are commonly used. To achieve a color effect, there are currently two primary approaches: one is to use a single-layer optical waveguide for RGB, which is lightweight and thin but has a limited field of view, only capable of providing a small field of view; the other approach is to use three layers of waveguides, which can provide a medium to large field of view but results in a bulkier optical waveguide. It is evident that it is difficult to achieve both a slim and lightweight design and a large field of view of the optical waveguide, which significantly limits the development and popularization of the AR display technology.

### SUMMARY

An objective of the present disclosure is to provide new technical solutions for an optical waveguide structure, an optical module and a head-mounted display device.

In a first aspect, the present disclosure provides an optical waveguide structure, which includes an optical waveguide, and a coupling-out zone and at least two coupling-in zones provided on the optical waveguide;

the at least two coupling-in zones are configured for coupling in light of different colors;

the coupling-out zone is configured for coupling the light, which has been coupled in through the at least two coupling-in zones, out of the optical waveguide at different field angles, respectively.

Optionally, the coupling-out zone is configured for coupling the light, which has been coupled in through at least one of the coupling-in zones, out of the optical waveguide at a full field angle, and for coupling the light, which has been coupled in through at least one of the coupling-in zones, out of the optical waveguide at a half field angle.

Optionally, the optical waveguide is a single-layer colored optical waveguide.

Optionally, the optical waveguide is provided with a pupil expansion region on a surface thereof, and light of different colors enters the optical waveguide through corresponding coupling-in zones, and passes through the pupil expansion region before being emitted from the same coupling-out zone.

Optionally, each of the coupling-in zones, the coupling-out zone, and the pupil expansion region is provided with a one-dimensional grating structure.

Optionally, the one-dimensional grating structure includes any one of a binary grating, a blazed grating, a slanted grating, and a volume holographic grating.

Optionally, the optical waveguide structure has a field angle no less than 35°.

In a second aspect, the present disclosure provides an optical module, which includes a first optical waveguide structure and a second optical waveguide structure, the first optical waveguide structure corresponds to a left eye, and the second optical waveguide structure corresponds to a right eye, wherein each of the first optical waveguide structure and the second optical waveguide structure is the above optical waveguide structure;

light with different fields of view coupled out through the first optical waveguide structure all enters the left eye, light with different fields of view coupled out through the second optical waveguide structure all enters the right eye, and the light entering the left eye and the light entering the right eye are superimposed by binocular complementarity to form a complete field of view.

Optionally, full-field light and half-field light coupled out through the first optical waveguide structure both enter the left eye, full-field light and half-field light coupled out through the second optical waveguide structure both enter the right eye, and the half-field light entering the left eye and the half-field light entering the right eye are superimposed by binocular complementarity to form a complete field of view.

In a third aspect, the present disclosure provides a head-mounted display device, which includes:

a housing; and

the above optical module, the optical module being provided in the housing.

According to the embodiments of the present disclosure, the optical waveguide structure is designed to include one coupling-out zone and at least two coupling-in zones. In application, the optical waveguide structure couples light of different colors separately into the optical waveguide, and the light of different colors is coupled out of the same coupling-out zone with different fields of view. Subsequently, by complementing the field of view with binocular complementarity, it is possible to expand the field of view of a single-layer optical waveguide, and improve the field of view of the optical waveguide structure without increasing its size in the thickness direction, thereby improving the user's visual experience.

Other features and advantages of the present disclosure will become apparent from the following detailed description of exemplary embodiments of the present disclosure with reference to the accompanying drawings.

### BRIEF DESCRIPTION OF THE DRAWINGS

In order to more clearly illustrate embodiments of the present disclosure or technical solutions in the prior art, accompanying drawings that need to be used in description of the embodiments or the prior art will be briefly introduced as follows. Obviously, drawings in following description are only a part of drawings of the present disclosure. For those skilled in the art, other drawings can also be obtained according to the disclosed drawings without creative efforts.

FIG. 1 is a first structural schematic diagram of the optical waveguide structure provided in an embodiment of the present disclosure;

FIG. 2 is a second structural schematic diagram of the optical waveguide structure provided in an embodiment of the present disclosure;

FIG. 3 is a third structural schematic diagram of the optical waveguide structure provided in an embodiment of the present disclosure;

FIG. 4 is a transmission image in vector space (K-space) of the blue light received by the coupling-in zone of the optical waveguide structure shown in FIGS. 1 to 3.

FIG. 5 is a transmission image in vector space (K-space) of the green light received by the coupling-in zone of the optical waveguide structure shown in FIGS. 1 to 3.

FIG. 6 is a transmission image in vector space (K-space) of the red light received by the coupling-in zone of the optical waveguide structure shown in FIGS. 1 to 3.

FIG. 7 is a first structural schematic diagram of the optical waveguide structure provided in another embodiment of the present disclosure;

FIG. 8 is a second structural schematic diagram of the optical waveguide structure provided in another embodiment of the present disclosure;

FIG. 9 is a third structural schematic diagram of the optical waveguide structure provided in another embodiment of the present disclosure;

FIG. 10 is a transmission image in vector space (K-space) of the blue light received by the coupling-in zone of the optical waveguide structure shown in FIGS. 7 to 9.

FIG. 11 is a transmission image in vector space (K-space) of the green light received by the coupling-in zone of the optical waveguide structure shown in FIGS. 7 to 9.

FIG. 12 is a transmission image in vector space (K-space) of the red light received by the coupling-in zone of the optical waveguide structure shown in FIGS. 7 to 9.

FIG. 13 is a first structural schematic diagram of the optical waveguide structure provided in yet another embodiment of the present disclosure;

FIG. 14 is a second structural schematic diagram of the optical waveguide structure provided in yet another embodiment of the present disclosure;

FIG. 15 is a third structural schematic diagram of the optical waveguide structure provided in yet another embodiment of the present disclosure;

FIG. 16 is a transmission image in vector space (K-space) of the blue light received by the coupling-in zone of the optical waveguide structure shown in FIGS. 13 to 15.

FIG. 17 is a transmission image in vector space (K-space) of the green light received by the coupling-in zone of the optical waveguide structure shown in FIGS. 13 to 15.

FIG. 18 is a transmission image in vector space (K-space) of the red light received by the coupling-in zone of the optical waveguide structure shown in FIGS. 13 to 15.

### DESCRIPTION OF REFERENCE SIGNS

10, optical machine group; 11, first optical machine; 12, second optical machine; 13, third optical machine; 20, optical waveguide; 21, coupling-out zone; 22, coupling-in zone; 23, pupil expansion region; 01, left eye; 02, right eye.

### DETAILED DESCRIPTION

Various exemplary embodiments of the present disclosure will now be described in detail with reference to the accompanying drawings. It should be noted that the relative arrangements, numerical expressions, and values of the components and steps set forth in these embodiments do not limit the scope of the present disclosure unless otherwise specifically stated.

The following description of at least one exemplary embodiment is in fact merely illustrative and is in no way intended as a limitation to the present disclosure and its application or use.

Technologies, methods and devices known to those of ordinary skill in the related field may not be discussed in detail; however, the technologies, methods and devices should be regarded as a part of the specification where appropriate.

In all examples shown and discussed herein, any specific value should be interpreted as merely exemplary rather than a limitation. Therefore, other examples of the exemplary embodiments may have different values.

It should be noted that similar reference numerals and letters represent similar items in the accompanying drawings below. Therefore, once an item is defined in one drawing, it is unnecessary to further discuss the item in the subsequent drawings.

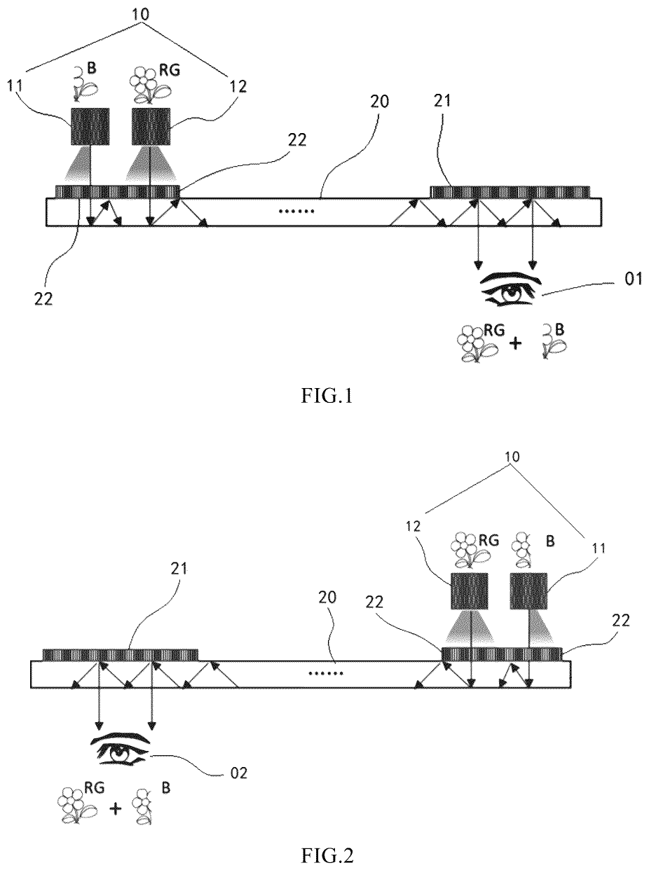

Embodiments of the present disclosure provide an optical waveguide structure, as shown in FIGS. 1 to 3, FIGS. 7 to 9, and FIGS. 13-15. The optical waveguide structure includes an optical waveguide 20, and a coupling-out zone 21 and at least two coupling-in zones 22 provided on the optical waveguide 20;

wherein the at least two coupling-in zones 22 are configured for coupling in light of different colors;

the coupling-out zone 21 is configured for coupling the light, which has been coupled in through the at least two coupling-in zones 22, out of the optical waveguide 20 at different field angles, respectively.

Optical waveguide technology has been widely applied in the augmented reality display devices. One of the development trends in the augmented reality display devices is to project light that covers as much of the human eye's visible field of view as possible. However, in prior art, to enable the augmented reality display devices to achieve a larger field of view, a three-layer structure of the optical waveguide structure is usually used, which increases the thickness dimension of the optical waveguide structure.

According to the embodiments of the present disclosure, the optical waveguide structure is designed as a single-layer structure and is provided with one coupling-out zone and at least two coupling-in zones. In application, the optical waveguide structure couples light of different colors separately into the optical waveguide 20, and the light of different colors is coupled out of the same coupling-out zone 21 with different fields of view. Subsequently, by using binocular complementarity to complement the field of view, it is possible to expand the field of view of a single-layer optical waveguide, thereby improving the field of view of the optical waveguide structure without increasing the size in the thickness direction of the entire optical waveguide structure, and thus enhancing the user's visual experience.

It should be noted that, in the embodiments of the present disclosure, the light of different colors coupled into the optical waveguide structure may be emitted by different optical machines. Of course, the light may also be emitted by the same optical machine and then processed by a beam splitter or filter element to form light of different colors before being coupled into the optical waveguide structure.

In the embodiments of the present disclosure, light of different colors may be coupled in through different coupling-in zones 22 on the optical waveguide structure, and after propagating within the optical waveguide 20, the light is coupled out of the same coupling-out zone 21 with different fields of view.

In a specific embodiment of the present disclosure, light of different colors may be emitted by different optical machines. As such, an optical machine group 10 may be provided, which may include at least two optical machines to emit light of different colors. On this basis, the coupling-in zones 22 on the optical waveguide 20 are provided in a one-to-one correspondence with the optical machines. Each coupling-in zone 22 is configured for allowing the light emitted by the corresponding optical machine to enter the optical waveguide 20 for propagation. The out-coupling region 21 is configured for coupling the light, which is coupled into the optical waveguide 20, out of the optical waveguide 20 at different field angles.

For example, in the same optical machine group 10: each optical machine may emit light of one color or a plurality of colors, but the colors of the light emitted by different optical machines are different. Thus, when different optical machines emit light of different colors, each coupling-in zones 22 on the optical waveguide 20 can receive light of a specific color emitted by a corresponding optical machine.

In some examples of the present disclosure, the out-coupling region 21 is configured for coupling the light, which has been coupled in through at least one of the coupling-in zones 22, out of the optical waveguide 20 at a full field angle, and for coupling the light, which has been coupled in through at least one of the coupling-in zones 22, out of the optical waveguide 20 at a half field angle.

In the embodiments of the present disclosure, light of different colors may enter the optical waveguide 20 through different coupling-in zones 22 respectively for transmission. When the light propagating within the optical waveguide 20 reaches the coupling-out zone 21, the light from the each coupling-in zones 22 may be coupled out of the optical waveguide 20 through the same coupling-out zone 21. When the light is coupled out of the same coupling-out zone 21, a part of the light may be coupled out with a full field of view, while the other part of the light may be coupled out with a half field of view. Ultimately, the field of view may be completed through binocular complementarity, thereby expanding the field of view for imaging.

In the embodiments of the present disclosure, the optical waveguide 20 may be provided with two, three, or more coupling-in zones 22, while only one coupling-out zone 21 is provided, meaning that all the coupling-in zones 22 share the same coupling-out zone 21. When there are at least two coupling-in zones 22, for example, one coupling-in zone 22 may be designed as the main coupling-in zone, and the other coupling-in zone 22 may be designed as the auxiliary coupling-in zone. Specifically:

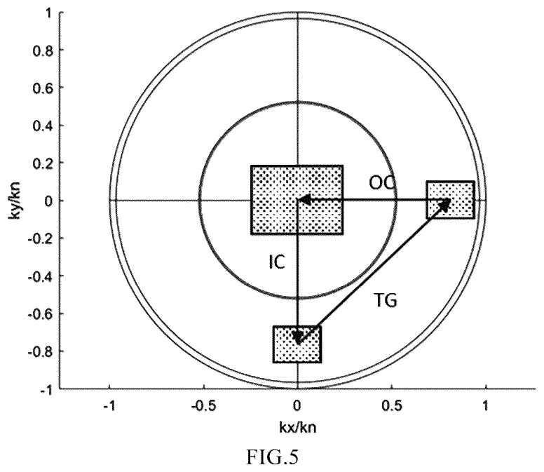

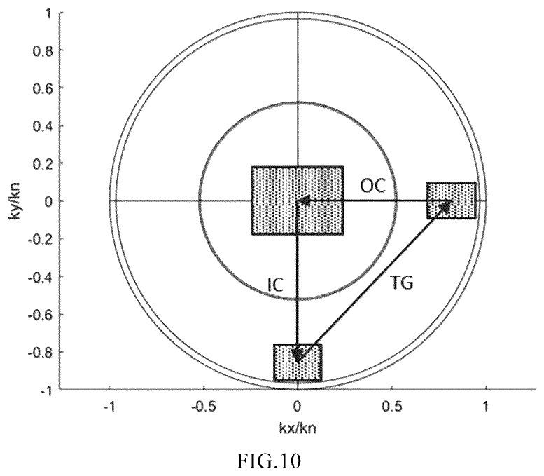

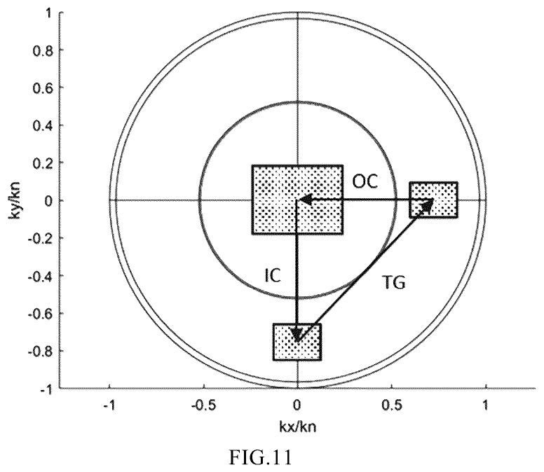

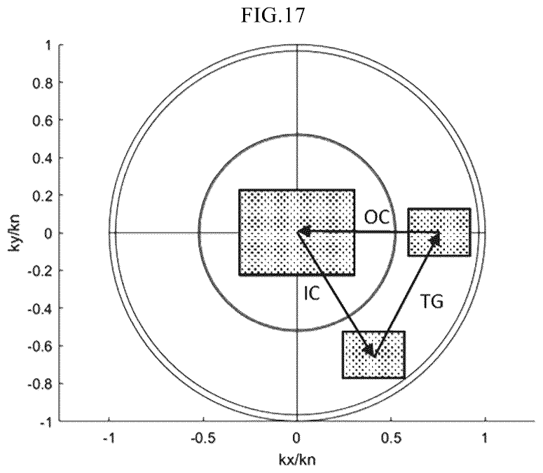

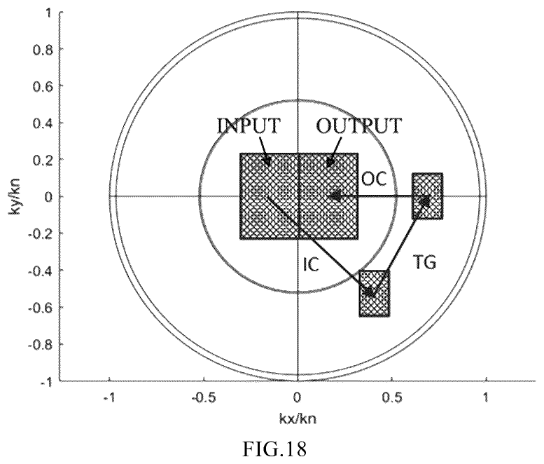

The light of a specific color received by the main coupling-in zone, when coupled out through the coupling-out zone 21, has a complete field of view, which allows the grating through which the light of the main coupling-in zone passes to satisfy the vector closure, see FIGS. 5, 6, 10, 11, and 17. Due to the absence of some colors of light in the light entering the main in-coupling region, the optical waveguide 20 can accommodate a larger field of view within its transmission range.

Since the light received by the auxiliary coupling-in zone shares the same coupling-out zone 21 with the light received by the main coupling-in zone, the grating vector does not satisfy the closure relationship any more, see FIGS. 4, 12, 16, and 18. By designing the grating vector of the auxiliary coupling-in zone, the light of other colors received by the auxiliary coupling-in zone may have only half the field of view after being coupled out through the coupling-out zone 21. Thus, the field of view may be complemented through binocular complementarity to form a complete field of view.

In the embodiments of the present disclosure, the optical waveguide structure is designed to have a larger field of view than that of a traditional optical waveguide structure, thereby achieving an expanded field of view for the optical waveguide structure.

It should be noted that the number of coupling-in zones 22 provided on the optical waveguide 20 is not limited in the embodiments of the present disclosure and can be set according to the requirements of the image output by the display device in application.

In some examples of the present disclosure, the optical waveguide 20 is a single-layer colored optical waveguide.

That is to say, on the basis of the single-layer colored optical waveguide, the solution of the embodiment of the present disclosure provides two or more coupling-in zones 22 to allow light of different colors to enter the interior of the optical waveguide 20 respectively for different transmissions, and then be coupled out of the optical waveguide 20 through the same coupling-out zone 21 at different field angles.

In the embodiments of the present disclosure, in the design of a single-layer colored optical waveguide, different coupling-in zones 22 are designed for light of different colors, and the light of each color, after passing through the same coupling-out zone 21, has a half or more than half field angle. Then, the complete field of view is formed through binocular complementarity, thereby expanding the field of view.

In the embodiments of the present disclosure, only one layer of optical waveguide structure is used, and a larger field of view for imaging may be achieved by completing the field of view through binocular complementarity. Therefore, the optical waveguide structure may be both lightweight and thin while having a large field of view. That is, the optical waveguide structure may achieve both a thin and lightweight design and a large field of view.

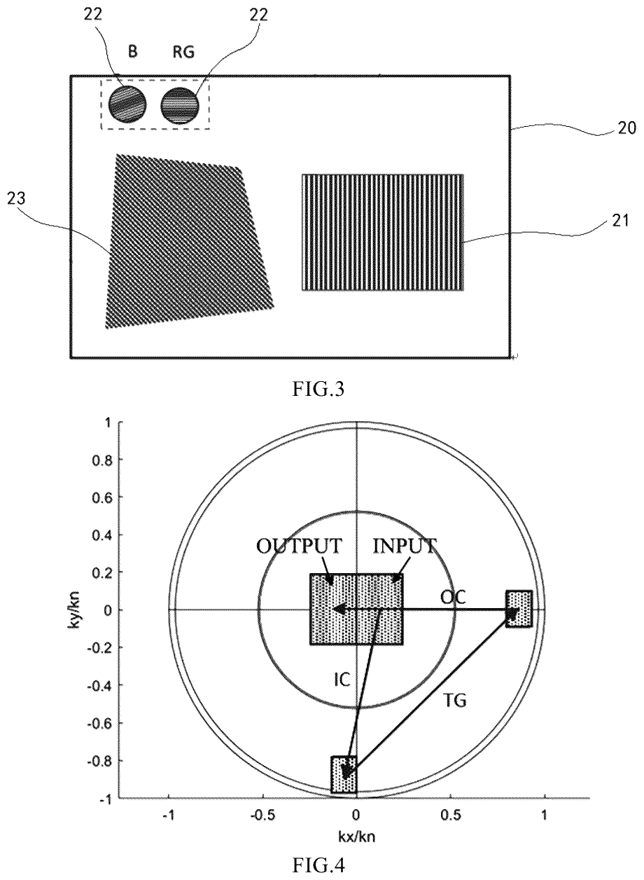

In some examples of the present disclosure, as shown in FIGS. 3, 9, and 15, the optical waveguide 20 is provided with a pupil expansion region 23 on its surface. Light of different colors enters the optical waveguide 20 through corresponding in-coupling regions 22, and is emitted from the same out-coupling region 21 after passing through the pupil expansion region 23.

In the embodiments of the present disclosure, the reason for providing a pupil expansion region 23 on the optical waveguide 20 is that, in a near-eye display system, the size of the display light source is relatively small, and thus the human eye obtains a relatively small picture in the process of viewing the corresponding display screen. After the pupil expansion region 23 is provided on the optical waveguide 20, the incident light may enter through the coupling-in zone 22, and be emitted from the coupling-out zone 21 after passing through the pupil expansion region 23. The pupil expansion region 23 may be configured for expanding the emergent angle of the incident light, thereby contributing to forming a larger picture size. As a result, the viewing experience is improved when the user sees a larger picture size.

In some examples of the present disclosure, each of the in-coupling regions 22, the out-coupling region 21, and the pupil expansion region 23 is provided with a one-dimensional grating structure.

For example, a first grating is provided at each coupling-in zone 22.

For example, the first grating may be attached as a separate optical element to the corresponding coupling-in zone 22. Of course, it is also possible to fabricate the structure of the first grating at the position where the coupling-in zone 22 of the optical waveguide 20 is located.

The light corresponding to the first grating may be directly emitted to the first grating and enter into the interior of the optical waveguide 20, allowing the incident light to propagate within the optical waveguide 20. For example, the density of the medium inside the optical waveguide 20 is greater than that of the external medium.

For example, a second grating is provided where the coupling-out zone 21 is located.

For example, the second grating may be attached as a separate optical element to the coupling-out zone 21. Of course, it is also possible to fabricate the structure of the second grating at the position where the coupling-out zone 21 of the optical waveguide 20 is located.

On the same optical waveguide 20, when the light from each coupling-in zones 22 reaches the coupling-out zone 21 after total internal reflection, the incident angle will be deflected again under the action of the second grating, and the incident light will transmit through the optical waveguide 20. The display image formed by the light emitted through the coupling-out zone 21 can be captured by the human eye, i.e., the image is displayed in the human eye.

For example, a third grating is provided at a position where the pupil expansion region 23 is located.

For example, the third grating may be attached as a separate optical element to the pupil expansion region 23. Of course, it is also possible to fabricate the structure of the third grating at the position where the pupil expansion region 23 of the optical waveguide 20 is located.

The third grating may be configured for expanding the emergent angle of the incident light, thereby obtaining a larger emergent angle range and thus forming a larger picture size.

Here, the first grating, the second grating, and the third grating are all one-dimensional gratings.

In some examples of the present disclosure, the one-dimensional grating structure includes any one of a binary grating, a blazed grating, a slanted grating, or a volume holographic grating.

That is to say, in the embodiments of the present disclosure, the first grating provided at each coupling-in zone 22, the second grating provided at the coupling-out zone 21, and the third grating provided at the pupil expansion region 23 may be flexibly selected from the above-mentioned types of one-dimensional gratings according to specific needs. The types of the first grating, the second grating, and the third grating may be the same or different, and are not specifically limited in the embodiments of the present disclosure.

The above one-dimensional grating, when applied to the coupling-in zone 22, has a high light coupling efficiency, enabling more light to be coupled into the interior of the optical waveguide 20.

The above one-dimensional grating, when applied to the pupil expansion zone 23, may be configured for expanding the emergence angle of the incident light.

The above one-dimensional grating, when applied to the coupling-out zone 21, enables more light to enter the eye, thereby better forming an image in the eye.

In the embodiments of the present disclosure, the coupling-in zone 22, the coupling-out zone 21, and the pupil expansion zone 23 may be designed to be provided on the same surface of the optical waveguide 20. In this way, light of different colors may enter from one side and exit from another region on the same side. At this point, the display light source and the human eye are on the same side, allowing the optical elements to be provided on the same side of the optical waveguide 20, thus avoiding the need to place optical elements on both sides of the optical waveguide 20 and reducing its volume to some extent.

Of course, in the embodiments of the present disclosure, the coupling-in zone 22, the coupling-out zone 21, and the pupil expansion zone 23 may also be designed to be provided on different surfaces of the optical waveguide 20. This design allows for more flexible selection of the incidence direction of the light emitted by the optical machine and the direction of the light exiting from the coupling-out zone 21.

In some examples of the present disclosure, the field angle of the optical waveguide structure can reach no less than 35°.

This is larger than the field of view of a traditional optical waveguide structure. The embodiments of the present disclosure can effectively expand the field of view of a single-layer color waveguide, achieving the effect of being thin and light with a large field of view.

In a specific embodiment of the present disclosure, as shown in FIGS. 1 to 3, one optical machine group 10 is provided for the optical waveguide structure, which includes a first optical machine 11 and a second optical machine 12. One of the first optical machine 11 and the second optical machine 12 is configured for emitting red light (R) and green light (G) of the RGB light, and the other of the first optical machine 11 and the second optical machine 12 is configured for emitting blue light (B) of the RGB light.

As shown in FIGS. 1 to 3, the optical waveguide 20 is a single-layer colored optical waveguide, and is provided with two coupling-in zones 22 and one coupling-out zone 21; one of the coupling-in zones 22 corresponds to the first optical machine 11, the first optical machine 11 may be configured for emitting blue light (B), then the coupling-in zone 22 corresponding to the first optical machine 11 may allow blue light (B) to enter the interior of the optical waveguide 20 for propagation, and this coupling-in zone 22 is designated as the auxiliary coupling-in zone. The other coupling-in zone 22 corresponds to the second optical machine 12, which is configured for emitting red light (R) and green light (G). The coupling-in zone 22 corresponding to the second optical machine 12 may allow red light (R) and green light (G) to enter the interior of the optical waveguide 20 for propagation, and this coupling-in zone 22 is designated as the main coupling-in zone. It can be understood that blue light (B) alone enters the interior of the optical waveguide 20 for propagation through the auxiliary coupling-in zone, while red light (R) and green light (G) together enter the interior of the optical waveguide 20 for propagation through the main coupling-in zone. The coupling-out zone 21 allows the light from the above two coupling-in zones 22 to be coupled out of the optical waveguide 20.

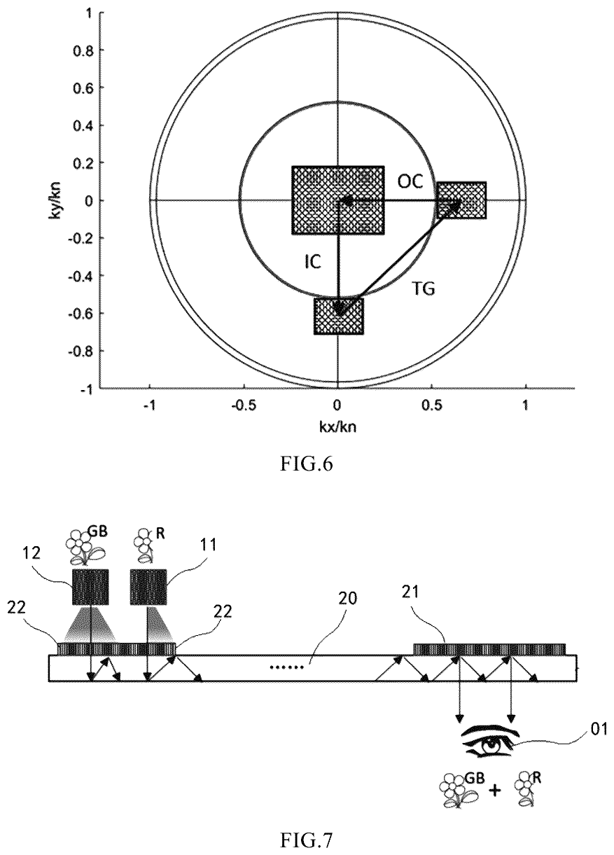

In the above embodiments: as shown in FIGS. 5 and 6, the grating through which the light from the main coupling-in zone (such as the above red light (R) and green light (G)) passes satisfies vector closure, and due to the lack of blue light (B), the optical waveguide 20 may accommodate a larger field of view within its transmission range. As shown in FIG. 4, the blue light from the auxiliary coupling-in zone shares the same coupling-out zone 21 with the main coupling-in zone, and thus the grating vector no longer satisfy the closure relationship.

Here, by designing the grating vector of the auxiliary coupling-in zone, it is possible to achieve a specific translation of the light vector relative to the incident light vector. Continuing with FIG. 4, the blue light (B) of the auxiliary coupling-in zone, after exiting from the coupling-out zone 21, has a field of view that is half or more of the field of view of the red light (R) and green light (G) entering into the main coupling-in zone. Through binocular complementarity, the light from the auxiliary coupling-in zone and the light from the main coupling-in zone may have the same complete field of view, making the field of view of the optical waveguide structure in the present disclosure larger than that of the traditional optical waveguide structure.

The above embodiment provides a dual-pupil structure, wherein the blue light (B) is configured to be received by the auxiliary coupling-in zone alone. After the light from the first optical machine 11 and the second optical machine 12 passes through the optical waveguide 20, the left eye may see a complete red-green image and the right half of the blue image (as shown in FIG. 1), and the right eye may see a complete red-green image and the left half of the blue image (as shown in FIG. 2). Through binocular complementarity, a complete color image may be obtained.

Furthermore, in the above embodiments: the grating period of the main coupling-in zone is 375 nm, with a direction of −90°; the grating period of the auxiliary coupling-in zone is 371 nm, with a direction of −98°; the grating period of the pupil expansion zone is 258°, with a direction of 43°; the grating period of the pupil expansion zone is 355 nm, with a direction of 180°; the field of view range is 35°.

In another specific embodiment of the present disclosure, as shown in FIGS. 7 to 9, one optical machine group 10 is provided for the optical waveguide structure, and the optical machine group 10 includes a first optical machine 11 and a second optical machine 12. One of the first optical machine 11 and the second optical machine 12 is configured for emitting green light (G) and blue light (B) of the RGB light, and the other is configured for emitting red light (R) of the RGB light.

As shown in FIGS. 7 to 9, the optical waveguide 20 is a single-layer colored optical waveguide, and is provided with two coupling-in zones 22 and one coupling-out zone 21. One of the coupling-in zones 22 corresponds to the first optical machine 11, the first optical machine 11 may be configured for emitting red light (R). The coupling-in zone 22 corresponding to the first optical machine 11 may allow red light (R) to enter the interior of the optical waveguide 20 for propagation, and this coupling-in zone 22 is designated as the auxiliary coupling-in zone. The other coupling-in zone 22 corresponds to the second optical machine 12, the second optical machine 12 may be configured for emitting blue light (B) and green light (G). The coupling-in zone 22 corresponding to the second optical machine 12 may allow blue light (B) and green light (G) to enter the interior of the optical waveguide 20 for propagation, and this coupling-in zone 22 is designated as the main coupling-in zone. It can be understood that red light (R) alone enters the interior of the optical waveguide 20 for propagation through the auxiliary coupling-in zone, and blue light (B) and green light (G) together enter the interior of the optical waveguide 20 for propagation through the main coupling-in zone. The coupling-out zone 21 may allow the light from the above two coupling-in zones 22 to be coupled out of the optical waveguide 20.

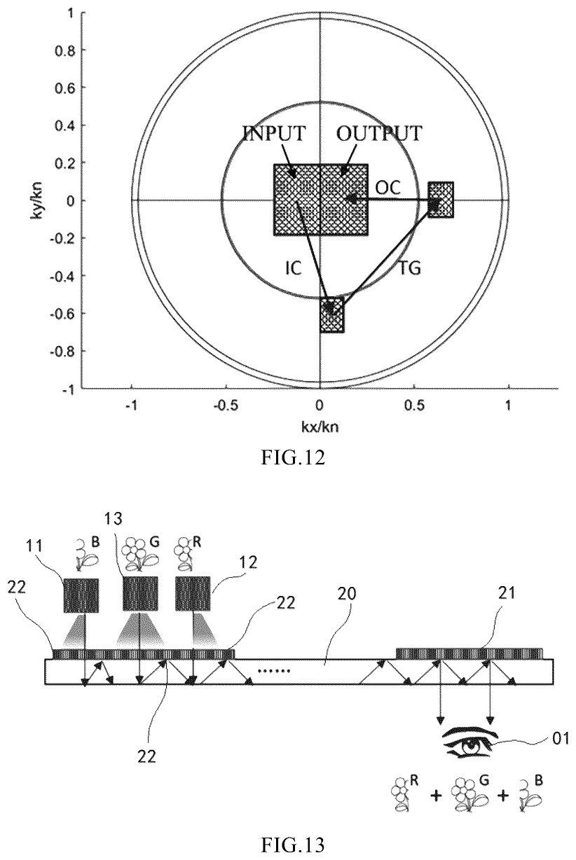

In the above embodiment: the grating through which the light from the main coupling-in zone (such as the above blue light (B) and green light (G)) passes meets vector closure, as shown in FIGS. 11 and 12; and due to the lack of red light (R), the optical waveguide 20 may accommodate a larger field of view within its transmission range. As shown in FIG. 12, the red light from the auxiliary coupling-in zone shares the same coupling-out zone 21 with the main coupling-in zone, and thus the grating vector no longer satisfies the closure relationship.

Here, by designing the grating vector of the auxiliary coupling-in zone, it is possible to achieve a specific translation of the light vector relative to the incident light vector. Continuing with FIG. 12, the red light (R) of the auxiliary coupling-in zone, after exiting from the coupling-out zone 21, has a field of view that is half or more of the field of view of the blue light (B) and green light (G) entering into the main coupling-in zone. Through binocular complementarity, the light from the auxiliary coupling-in zone and the light from the main coupling-in zone may have the same complete field of view, making the field of view of the optical waveguide structure in the present disclosure larger than that of the traditional optical waveguide structure.

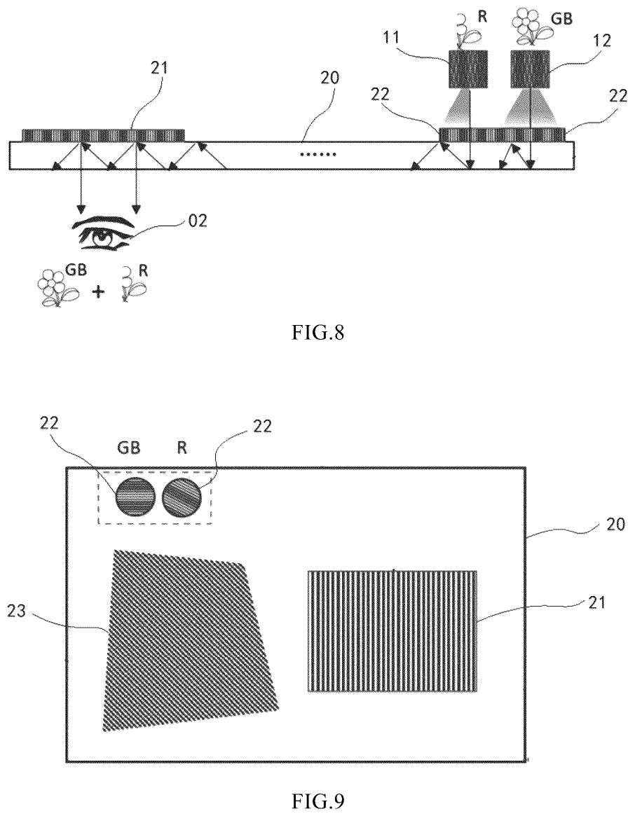

The above embodiment provides a dual-pupil structure, wherein the red light (R) is configured to be received by the auxiliary coupling-in zone alone. After the light from the first optical machine 11 and the second optical machine 12 passes through the single-layer colored optical waveguide, the left eye may see a complete blue-green image and the right half of the red image (as shown in FIG. 7), and the right eye may see a complete blue-green image and the left half of the red image (as shown in FIG. 8). Through binocular complementarity, a complete color image may be obtained.

Furthermore, in the above embodiment: the grating period of the main coupling-in zone is 380 nm, with a direction of −90°; the grating period of the auxiliary coupling-in zone is 330 nm, with a direction of −79°; the grating period of the pupil expansion zone is 276°, with a direction of 47°; the grating period of the pupil expansion zone is 400 nm, with a direction of 180°; the field of view range is 35°.

In another specific embodiment of the present disclosure, as shown in FIGS. 13 to 15, one optical machine group 10 is provided for the optical waveguide structure, and includes a first optical machine 11, a second optical machine 12, and a third optical machine 13; the first optical machine 11, the second optical machine 12, and the third optical machine 13 are configured for independently emitting the three different lights of the RGB light.

It can be understood that the first optical machine 11, the second optical machine 12, and the third optical machine 13 are configured for emitting red light (R), green light (G), and blue light (B) of the RGB light, respectively.

As shown in FIGS. 13 to 15, the optical waveguide 20 is a single-layer colored optical waveguide, and is provided with three coupling-in zones 22 and one coupling-out zone 21. One of the coupling-in zones 22 may correspond to the first optical machine 11, which may be configured for emitting blue light (B). The coupling-in zone 22 corresponding to the first optical machine 11 may allow blue light (B) to enter the interior of the optical waveguide 20 for propagation, and this coupling-in zone 22 is designated as the auxiliary coupling-in zone. Another coupling-in zone 22 may correspond to the second optical machine 12, which may be configured for emitting red light (R). The coupling-in zone 22 corresponding to the second optical machine 12 may allow red light (R) to enter the interior of the optical waveguide 20 for propagation, and this coupling-in zone 22 is designated as another auxiliary coupling-in zone. That is, the present embodiment provides two auxiliary coupling-in zones, which may receive blue light (B) and red light (R) independently, respectively. Additionally, there is another coupling-in zone 22 provided for the third optical machine 13, the third optical machine 13 may be configured for emitting green light (G). The coupling-in zone 22 corresponding to the third optical machine 13 may allow green light (G) to enter the interior of the optical waveguide 20 for propagation, and this coupling-in zone 22 is designated as the main coupling-in zone.

It can be understood that red light (R) and blue light (B) respectively enter the interior of the optical waveguide 20 for propagation through their respective auxiliary coupling-in zones, and green light (G) enters the interior of the optical waveguide 20 for propagation through the main coupling-in zone. The coupling-out zone 21 may couple the light from the three coupling-in zones 22 out of the optical waveguide 20.

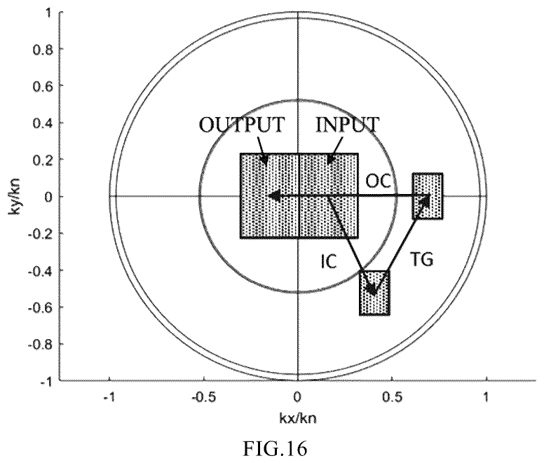

Here, by designing the grating vector of the auxiliary coupling-in zone, it is possible to achieve a specific translation of the light vector relative to the incident light vector. As shown in FIGS. 16 and 18, the blue light (B) and red light (R) from the auxiliary coupling-in zones, after exiting from the coupling-out zone 21, have a field of view that is half or more of the field of view of the green light (G) entering into the main coupling-in zone. Then through binocular complementarity, the light from the auxiliary coupling-in zones and the light from the main coupling-in zone may have the same complete field of view, making the field of view of the optical waveguide structure in the present disclosure larger than that of the traditional optical waveguide structure.

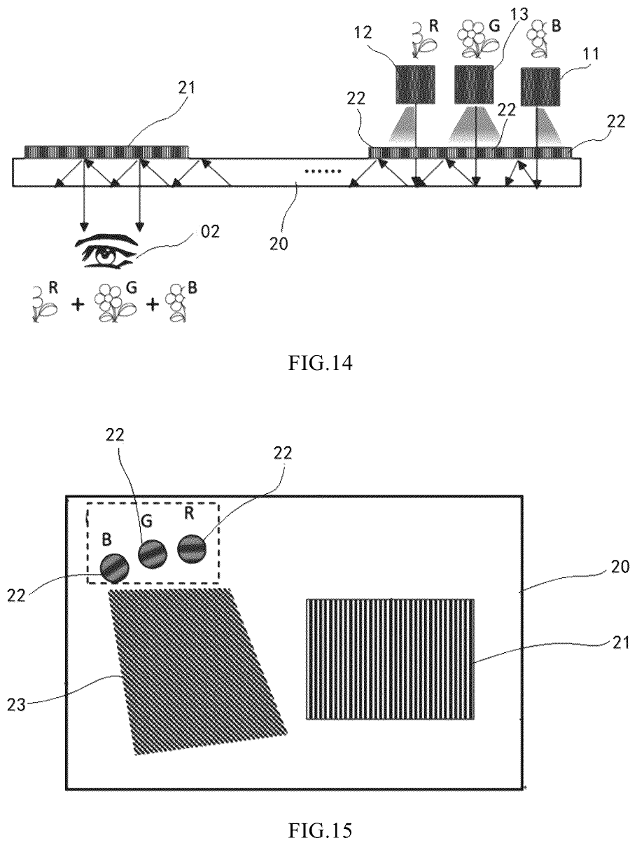

The above embodiment provides a tri-pupil structure, wherein the blue light (B) and red light (R) are each provided with a corresponding auxiliary coupling-in zone. After the light from the first optical machine 11, the second optical machine 12, and the third optical machine 13 passes through the single-layer colored optical waveguide, the left eye may see a complete green image, the left half of the red image, and the right half of the blue image (as shown in FIG. 13), and the right eye may see a complete green image, the right half of the red image, and the left half of the blue image (as shown in FIG. 14). Through binocular complementarity, a complete color image may be obtained.

Furthermore, in the above embodiment: the grating period of the main coupling-in zone is 375 nm, with a direction of −58°; the grating period of the auxiliary coupling-in zone for red light (R) is 323.5 nm, with a direction of −47°; the grating period of the auxiliary coupling-in zone for blue light (B) is 407.6 nm, with a direction of −68°; the grating period of the pupil expansion zone is 389°, with a direction of 62°; the grating period of the pupil expansion zone is 380 nm, with a direction of 180°; the field of view range is 45°.

In some examples of the present disclosure, on the optical waveguide 20, the coupling-in zones 22 are provided on the same side of the coupling-out zone 21.

For example, as shown in FIGS. 3 and 9, the projection positions on the optical waveguide 20 of one coupling-in zone 22 corresponding to the first optical machine 11 and the other coupling-in zone 22 corresponding to the second optical machine may be located on the same side as the projection position of the coupling-out zone 21 on the optical waveguide 20. For instance, they may all be located on the left side of the projection position of the coupling-out zone 21 on the optical waveguide 20, and of course, they may be on the right side; or they may be on the upper side or the lower side of the projection position of the coupling-out zone 21 on the optical waveguide 20.

For example, as shown in FIG. 15, the first optical machine 11 corresponds to one coupling-in zones 22, the second optical machine 12 corresponds to the other coupling-in zones 22, and the third optical machine 13 corresponds to another coupling-in zones 22. Projection positions on the optical waveguide 20 of these three coupling-in zones 22 may be located on the same side as the projection position of the coupling-out zone 21 on the optical waveguide 20. For instance, these three coupling-in zones 22 are all located on the left side of the projection position of the coupling-out zone 21 on the optical waveguide 20, and of course, they may be on the right side; or they may be on the upper side or the lower side of the projection position of the coupling-out zone 21 on the optical waveguide 20.

In some examples of the present disclosure, the optical axis of each optical machine is perpendicular to the plane of the optical waveguide 20.

For example, the optical axis of each optical machine is perpendicular to the optical waveguide 20, allowing the coupling-in zones 22 and the corresponding optical machines to be provided at one end of the optical waveguide 20.

Of course, the optical axes of the optical machines may also be set at an inclined angle relative to the plane of the optical waveguide 20 according to actual needs, which may be flexibly chosen by those skilled in the art and is not specifically limited in the embodiments of the present disclosure.

According to another aspect of the embodiments of the present disclosure, an optical module is further provided, which includes: a first optical waveguide structure and a second optical waveguide structure, the first optical waveguide structure corresponds to the left eye 01, and the second optical waveguide structure corresponds to the right eye 02. Each of the first optical waveguide structure and the second optical waveguide structure is the optical waveguide structure as described above;

light with different fields of view coupled out through the first optical waveguide structure all enters the left eye 01, light with different fields of view coupled out through the second optical waveguide structure all enters the right eye 02, and the light entering the left eye 01 and the light entering the right eye 02 are superimposed by binocular complementarity to form a complete field of view.

That is to say, the optical module includes two optical waveguide structures, which may correspond to the user's left eye 01 and right eye 02, respectively.

In the optical module provided by the embodiments of the present disclosure, light of different fields of view may be coupled out of each optical waveguide structure to enter the eyes. Some colors of light may be complemented through binocular complementarity to form a complete field of view, thereby enhancing the field of view range of the optical waveguide structure and thus improving the user's visual experience.

In some examples of the present disclosure, full-field light and half-field light coupled out through the first optical waveguide structure both enter the left eye 01, full-field light and half-field light coupled out through the second optical waveguide structure both enter the right eye 02. The half-field light entering the left eye 01 and the half-field light entering the right eye 02 are superimposed by binocular complementarity to form a complete field of view.

That is to say, when the user uses the above optical module, the full-field light and half-field light coupled out through the optical waveguide structure corresponding to the left eye 01 enter the left eye 01 together, and the full-field light and half-field light coupled out by the optical waveguide structure corresponding to the right eye 02 enter the right eye 02 together. Through binocular complementarity, the half-field may be complemented to form a complete field of view.

According to yet another aspect of the embodiments of the present disclosure, a head-mounted display device is provided, which includes:

a housing; and

the optical module as described above, the optical module being provided in the housing.

The housing forms an installation space, and the optical module and the optical machine group, etc., are provided in the installation space. The housing is used to protect and support the optical waveguide structure. At the same time, the installation space is also used to install various other components, such as power sources, etc.

In some examples of the present disclosure, the head-mounted display device may be augmented reality smart glasses, in which case the housing may be a frame. The first optical waveguide structure and the second optical waveguide structure are both provided on the frame.

The specific implementation of the head-mounted display device of the embodiments of the present disclosure may refer to the various embodiments of the optical waveguide structure mentioned above, and will not be repeated herein.

The above embodiments focus on the differences between the various embodiments, and the different optimization features between the various embodiments, as long as they do not contradict each other, may be combined to form a better embodiment, and will not be repeated herein considering the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical waveguide structure, comprising an optical waveguide, and a coupling-out zone and at least two coupling-in zones provided on the optical waveguide;
wherein the at least two coupling-in zones are configured for coupling in light of different colors;
the coupling-out zone is configured for coupling the light, which has been coupled in through the at least two coupling-in zones, out of the optical waveguide at different field angles.

2. The optical waveguide structure according to claim 1, wherein the coupling-out zone is configured for coupling the light, which has been coupled in through at least one of the coupling-in zones, out of the optical waveguide at a full field angle, and for coupling the light, which has been coupled in through at least another of the coupling-in zones, out of the optical waveguide at a half field angle.

3. The optical waveguide structure according to claim 1, wherein the optical waveguide comprises a single-layer colored optical waveguide.

4. The optical waveguide structure according to claim 1, wherein the optical waveguide is provided with a pupil expansion region on a surface thereof, and light of different colors is configured to enter the optical waveguide through corresponding coupling-in zones and pass through the pupil expansion region before being emitted from the coupling-out zone.

5. The optical waveguide structure according to claim 4, wherein each of the coupling-in zones, the coupling-out zone, and the pupil expansion region comprises a one-dimensional grating structure.

6. The optical waveguide structure according to claim 5, wherein the one-dimensional grating structure comprises one of a binary grating, a blazed grating, a slanted grating, and a volume holographic grating.

7. The optical waveguide structure according to claim 1, wherein the optical waveguide structure has a field angle no less than 35°.

8. An optical module, comprising a first optical waveguide structure and a second optical waveguide structure,
wherein, the first optical waveguide structure is configured to correspond to a left eye, the second optical waveguide structure is configured to correspond to a right eye, and each of the first optical waveguide structure and the second optical waveguide structure is the optical waveguide structure according to claim 1;
a first set of light with different fields of view coupled out through the first optical waveguide structure is configured to enter the left eye, a second set of light with different fields of view coupled out through the second optical waveguide structure is configured to enter the right eye, and the first set of light and the second set of light are configured to be superimposed by a binocular complementarity to form a complete field of view.

9. The optical module according to claim 8, wherein a first set of full-field light and half-field light coupled out through the first optical waveguide structure is configured to enter the left eye, a second set of full-field light and half-field light coupled out through the second optical waveguide structure is configured to enter the right eye, and the half-field light of the first set entering the left eye and the half-field light of the second set entering the right eye are configured to be superimposed by a binocular complementarity to form a complete field of view.

10. A head-mounted display device, comprising:
a housing; and
an optical module according to claim 8, provided in the housing.
